(19) United States
(12) Patent Application Publication
(10) Pub. No.: US 2008/0023673 A1
(43) Pub. Date: Jan. 31, 2008

(54) Stabilizer Composition for Colored Halogen-Containing Thermoplastic Resin Compositions

(76) Inventors: Walter Reith, Egenhofen (DE); Keith Lisle, Northumberland (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/570,763

(22) PCT Filed: Jun. 13, 2005
(86) PCT No.: PCT/EP05/06319

§ 371 Date: Aug. 31, 2007

(30) Foreign Application Priority Data
Jun. 24, 2004 (DE) 10 2004 028 821.6

(51) Int. Cl. C09K 15/32; C08J 3/20

(52) U.S. Cl. 252/400.61; 524/101

(57) ABSTRACT

The invention relates to a stabilizer composition which comprises at least one calcium compound and one isocyanurate bearing hydroxy groups and also one dye or one pigment or both for weathering-resistant thermoplastic resin compositions, in particular for weathering-resistant colored resin compositions based on polyvinyl chloride—(PVC)—where the composition has low content of β-diketones or is in essence free from β-diketones.

The invention relates to a stabilizer composition which comprises at least one calcium salt and also one dye or one pigment or both for weathering-resistant thermoplastic resin compositions, in particular for weathering-resistant colored resin compositions based on polyvinyl chloride—(PVC)—where the composition has low content of β-diketones or is in essence free from β-diketones.

Halogen-containing polymers are subject to a wide variety of chemical degradation reactions induced through use or by the environment, for example due to exposure to electromagnetic radiation or to heat or to combinations of two or more external effects, which can lead to disadvantageous impairment of performance characteristics or even to problems during processing. Degradation of halogenated polymers, in particular of PVC, often produces hydrochloric acid, which is eliminated from the polymer chain, the result being a discolored, unsaturated plastic with colorant polyene sequences.

A factor with particularly problematic effect here is that halogen-containing polymers require a relatively high processing temperature before they have the rheological parameters needed for processing. However, even at these temperatures marked decomposition of the polymer takes place in the case of unstabilized polymers, and this results not only in the undesired color change described above but also in a change in the properties of the material. Furthermore, the hydrochloric acid released from unstabilized, halogen-containing polymers at this processing temperature can lead to noticeable corrosion of processing plant. This phenomenon is significant particularly when production stoppages occur during processing of these halogenated polymers to give moldings, for example via extrusion, and the polymer melt remains in the extruder for a prolonged period. The abovementioned decomposition reactions can particularly occur during this period, making the batch within the extruder unusable and sometimes damaging the extruder.

In order to solve the problems mentioned, compounds known as stabilizers are usually added to halogen-containing polymers for processing purposes, these being intended to provide maximum inhibition of the abovementioned decomposition reactions. These stabilizers are generally solids which are added to the polymer intended for processing, before it is processed.

The use of calcium hydroxide as stabilizer for PVC is described by way of example in DE 29 35 689 A1. EP 0 394 547 B1 discloses the combination of overbased alkaline earth metal carboxylates with zeolite, with calcium hydroxide and with perchlorates.

WO 99/55777 describes a stabilizer composition for halogen-containing thermoplastic resin compositions. According to that publication, a mixture composed of optionally surface-modified calcium hydroxide and/or calcium oxide and of an isocyanurate containing hydroxy groups is proposed for stabilization.

Processing aids are generally indispensible for the controlled adjustment of properties during and after the processing of halogen-containing thermoplastic polymers. Issues attracting the attention of the processing industry are not only that the costs of these processing aids are often considerable but also that the overall property profile of a halogen-containing thermoplastic polymer is affected by stabilizers and processing aids. Stabilizers demanded for the processing of halogen-containing polymers are therefore increasingly those which bring about excellent processing properties together with stability appropriate to the particular requirements even when the amounts used are small. The prior art often proposes the use of β-diketones as a measure for improving the stabilizing properties of stabilizer compositions used for the stabilization of halogen-containing polymers.

By way of example, DE 694 29 805 T2 describes the use of β-diketones as stabilizers for halogen-containing polymers. Other publications which describe the use of compounds of that type for the stabilization of halogen-containing polymers are U.S. Pat. No. 5,475,145, EP 0 346 279 A1 or EP 0 307 358 A1, for example.

By way of example, the German patent application No. 10352762.1, unpublished at the priority date of the present invention, is concerned with the action of β-diketones in stabilizer compositions.

From the overall prior art it is apparent that the use of β-diketones as a constituent of stabilizer compositions has been recommended on grounds of improving thermal stability. Surprisingly, however, the presence of β-diketones in stabilizer compositions for halogen-containing polymers has a problematic effect in the case of colored halogen-containing polymers, i.e. in the case of polymer compositions which comprise dyes or pigments or both.

Materials composed of colored halogen-containing polymers are mainly used in the outdoor sector. Because of this, these materials are often in direct contact with environmental effects. Among these are in particular severe temperature variations, high-energy radiation, mechanical stress and the like. Particularly when the materials composed of halogen-containing polymers have been arranged so as to be visible, esthetic reasons frequently make it important that the external appearance of the material is not altered or is not altered more than necessary even during prolonged weathering.

Colored halogen-containing polymers often show bleaching of the material after prolonged weathering. A generally undesirable esthetic impairment of the component manufactured from this type of material when exposed to weathering of this type is also accompanied by impairment of mechanical stability. It has hitherto been accepted that when stabilizer compositions known from the prior art are used, bleaching of the material usually starts after a period of about 1000 h of artificial weathering. Surprisingly, this time can be observed in almost identical manner not only with frequently-used lead formulations but also with relatively new calcium-zinc-based formulations. Complete surface bleaching then takes place within a further period of up to about 500 h with the abovementioned formulations.

These alterations in the polymeric structure of this type of component lead to a lo wide variety of disadvantages. Users usually refuse to accept, or are unwilling to accept, these types of alterations in the appearance of a component used in the outdoor sector. A further disadvantage that should be stated is that the bleaching phenomenon can cause impairment of the mechanical properties of the molding.

The prior art has hitherto provided no indications as to how the abovementioned disadvantages can be avoided in the case of materials composed of colored halogen-containing polymers. A recommendation often encountered in this connection is to use appropriate stabilizers with respect to high-energy radiation, in particular with respect to UV radiation. While these measures certainly can bring about a slight delay in the bleaching process, the fundamental problem of unacceptably rapid alterations in the properties of the material remains unsolved.

An object underlying the invention is therefore to provide a stabilizer composition for halogen-containing thermoplastic resins which, unlike the formulations known from the prior art, exhibits adequate weathering resistance. Another object underlying the invention is to provide a stabilizer composition for halogen-containing thermoplastic resins which is particularly suitable for use in UPVC for the outdoor sector.

The invention achieves this object via a stabilizer composition for halogen-containing thermoplastic resins comprising by way of example
(a) at least one stabilizing calcium compound, for example calcium hydroxide and/or calcium oxide, where these may optionally have been surface-modified, or a calcium salt of an organic carboxylic acid and
(b) at least one dye or at least one pigment or both and
(c) at least one isocyanurate bearing hydroxy groups,
   where, based on the entire stabilizer composition, the content of β-diketones is less than 0.1% by weight in the stabilizer composition.

The present invention therefore provides a stabilizer composition for the stabilization of halogen-containing thermoplastic resins, comprising
(a) at least one stabilizing calcium compound or one mixture composed of two or more such compounds as component A and
(b) at least one dye or one pigment or their mixture as component B and
(c) at least one isocyanurate bearing hydroxy groups or one mixture composed of two or more such compounds as component C,
   where, based on the entire stabilizer composition, the content of β-diketone or salts of a β-diketone or their mixtures is less than 0.1% by weight in the stabilizer composition.

A stabilizer composition of the present invention is in principle suitable for the stabilization of compositions which comprise at least one halogen-containing polymer, in particular at least one halogen-containing thermoplastic resin. The invention provides here that an inventive stabilizer composition comprises at least one stabilizing calcium compound, for example a stabilizing calcium salt. Suitable stabilizing calcium compounds are in principle any of the calcium compounds, such as calcium salts, which have a stabilizing effect on halogen-containing thermoplastic resins, in particular a stabilizing effect with respect to degradation via thermal stresses such as in particular those occurring during the processing of these halogen-containing thermoplastic resins.

By way of example, a suitable component A is calcium oxide or calcium hydroxide or their mixture, in essence in any desired form. Calcium oxide or calcium hydroxide are preferably used here in powder form. Suitable powders can have a size distribution of the powder particles which is in essence as desired, as long as the stabilizing result is not impaired by the particle size distribution selected or is not impaired substantially more than is tolerable in the circumstances. Similar considerations apply to the BET surface area of the particles used.

By way of example, for the purposes of the present invention use is made of calcium oxide particles or calcium hydroxide particles whose D50 value for the particle size distribution is about 30 μm or less, in particular less than about 10 μm or less than about 5 μm. The secondary particle size (agglomerate size) should not exceed a value of about 40 μm. The secondary particle size is preferably less than about 40 μm, in particular less than about 30 μm or less than about 20 μm.

The calcium oxide or calcium hydroxide particles can optionally have been surface-modified in a manner known to the person skilled in the art. Particles surface-modified with stearic acid or with 12-hydroxystearic acid are particularly suitable.

Other suitable stabilizing calcium compounds are calcium soaps of saturated, unsaturated, straight-chain or branched, aromatic, cycloaliphatic or aliphatic carboxylic acids or hydroxycarboxylic acids preferably having from about 2 to about 22 carbon atoms.

Examples of suitable carboxylic acid anions comprise anions of monovalent carboxylic acids, such as acetic acid, propionic acid, butyric acid, valeric acid, hexanoic acid, enanthic acid, octanoic acid, neodecanoic acid, 2-ethylhexanoic acid, pelargonic acid, decanoic acid, undecanoic acid, dodecanoic acid, tridecanoic acid, myristylic acid, palmitic acid, laurylic acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids and, respectively, their monoesters, such as oxalic acid, malonic acid, maleic acid, tartaric acid, cinnamic acid, mandelic acid, malic acid, glycolic acid, oxalic acid, salicylic acid, polyglycoldicarboxylic acids whose degree of polymerization is from about 10 to about 12, phthalic acid, isophthalic acid, terephthalic acid or hydroxyphthalic acid, anions of tri- or tetravalent carboxylic acids, respectively, their mono-, di- or triesters, such as hemimellitic acid, trimellitic acid, pyromellitic acid or citric acid or else what are known as overbased carboxylates as described by way of example in DE-A 41 06 404 or in DE-A 40 02 988, the disclosure of the latter documents being incorporated as part of the disclosure of the present text.

For the purposes of one preferred embodiment of the present invention calcium soaps are preferably used whose anions derive from saturated or unsaturated carboxylic acids or from hydroxycarboxylic acids having from about 8 to about 20 carbon atoms. Particularly suitable compounds here are stearates, oleates, laurates, palmitates, behenates, versatates, hydroxystearates, dihydroxystearates, p-tert-butylbenzoates or (iso)octanoates of calcium or mixtures composed of two or more thereof. For the purposes of another embodiment of the present invention an inventive stabilizer composition comprises, for example, calcium stearate.

The invention has found that particularly good results can be achieved if the stabilizer composition comprises, based on the thermoplastic resin(s) to be stabilized, an amount of from 0.01 to 30 phr or from about 0.02 to about 20 phr or up to about 10 phr, of component A. Particularly suitable proportions of component A are by way of example in the range from about 0.05 to about 3.0 phr or within the range from about 0.08 to about 2.0 phr. Other amounts likewise suitable are, by way of example, from about 0.1 to about 1.5 phr, for example from about 0.15 to about 1.0 phr or from about 0.2 to about 0.8 phr or from about 0.25 to about 0.5 phr.

An inventive stabilizer composition comprises, alongside a stabilizing calcium salt or a mixture composed of two or more such salts, at least one dye or at least one pigment or one mixture composed of at least one dye and of at least one pigment as component B.

For the purposes of the present invention, therefore, an inventive stabilizer composition relates to the stabilization of colored halogen-containing polymers. For the purposes of the present invention the term “colored” relates here to chromaticity coordinates L≦95 measured with illuminant D65 in the Lab system, irrespective of the values measured in each case for the letters a and b. The term “colored” in particular covers those chromaticity coordinates in which L≦95, a=0±>1 or b=0±>1 or a=0±>1 and b=0±>1. By way of example, therefore, the “terracotta” shade often used in the context of production of PVC pipes features the following chromaticity coordinates: L=about 45, a=about 30 and b=about 37.

The term “stabilizer composition” used for the purposes of the present text can therefore on the one hand refer to a stabilizer composition itself having the abovementioned ingredients. However, it can moreover likewise refer to a stabilizer composition present by this stage within a polymer composition, irrespective of the manner in which it has arisen. The inventive term “stabilizer composition” can therefore by way of example also cover stabilizer compositions which have been previously mixed with polymer materials, where the individual ingredients of the stabilizer composition and a dye or a pigment or both have been introduced in their entirety to some extent in succession into the polymer.

Suitable dyes for use for the purposes of the present stabilizer compositions are in principle any of the dyes which give the desired chromaticity coordinates to a polymer composition comprising said dye. Suitable pigments for use for the purposes of the present stabilizer compositions are correspondingly in principle any of the pigments which give the desired chromaticity coordinates to a polymer composition comprising said pigment. Examples worthy of mention here are the oxides, sulfides, chromates and carbon, these usually being classified as inorganic pigments. Organic dyes and pigments are likewise suitable, in particular those from the group of the azo dyes and azo pigments or else from the group of the polycyclic aromatic compounds.

Examples of particularly suitable dyes and pigments are iron oxide, copper oxide, chromium oxide, mixed oxides containing copper and chromium or copper and iron or copper and chromium and iron in differing proportions, carbon blacks, iron oxide yellow, nickel titanium yellow, Cd sulfide, Cd selenide, lead chromate, lead molybdate, chromium oxide, Sb oxide, iron oxide red grades, ultramarines, cobalt blue grades, chromium oxide dihydrate, chromium oxide, cobalt green, Hansa pigments, benzidine pigments, toluidine pigments, lithol red grades, green gold, naphthol AS grades, azo condensation pigments, metal complex pigments, anthrapyrimidine, anthranthrone, perylenes, pyranthrone, quinophthalone, trans-perinone, thioindigo grades, quinacridones, isoviolanthrone, aniline black, indanthrene blue, dioxazines, phthalocyanine blue grades, phthalocyanine blue-green grades or phthalocyanine green grades.

The invention has found that particularly good results can be achieved if the stabilizer composition comprises, based on the thermoplastic resin(s) to be stabilized, an amount of from 0.01 to 30 phr or from about 0.02 to about 20 phr or up to about 10 phr, of component B. Particularly suitable proportions of component B are by way of example in the range from about 0.05 to about 6.0 phr or within the range from about 0.08 to about 4.0 phr. Other amounts likewise suitable are, by way of example, from about 0.1 to about 3 phr, for example from about 0.15 to about 2.0 phr or from about 0.2 to about 1.6 phr or from about 0.25 to about 1 phr.

An inventive stabilizer composition also comprises other compounds alongside components A and B. The invention has shown that it is advantageous for an inventive stabilizer composition to comprise at least one isocyanurate bearing hydroxy groups, in order to improve the stabilizing effect. An inventive stabilizer composition therefore comprises, alongside a stabilizing calcium salt or a mixture composed of two or more such salts and alongside the dyes or pigments or alongside a mixture composed of a dye and a pigment, at least one isocyanurate bearing hydroxy groups or one mixture composed of two or more such compounds as component C.

For the purposes of the present invention, a suitable component C is in principle any of the isocyanurates which have at least one OH group. However, for the purposes of one preferred embodiment of the present invention, isocyanurates are used which contain at least two OH groups. However, for the purposes of the present invention it is particularly preferable to use isocyanurates which have three OH groups.

For the purposes of one particularly preferred embodiment of the present invention, the isocyanurate containing hydroxy groups is selected from compounds of the general formula (II)

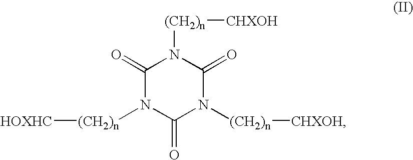

in which the groups X and the indices n are identical or different and n is a whole number from 0 to 5 and X is a hydrogen atom or a linear or branched alkyl group having from 1 to 6 carbon atoms.

Particular preference is given here to tris(hydroxyethyl) isocyanurate (hereinafter termed THEIC) and also to hindered phenolic isocyanurates of EP 0 685 516 B1, the disclosure of which with regard to appropriate hindered phenolic isocyanurates is expressly incorporated by way of reference and the disclosure of which concerning these isocyanurates is part of the disclosure of the present text.

The invention has found that particularly good results can be achieved if the stabilizer composition comprises, based on the thermoplastic resin(s) to be stabilized, an amount of from 0.001 to 10 phr or from about 0.002 to about 8 phr or up to about 5 phr, of component C. Particularly suitable proportions of component C are by way of example in the range from about 0.005 to about 3.0 phr or within the range from about 0.005 to about 2.0 phr. Other amounts likewise suitable are, by way of example, from about 0.01 to about 1.0 phr, for example from about 0.02 to about 0.5 phr or by way of example from about 0.05 to about 0.3 phr or less, for example up to about 0.299 phr, based on the thermoplastic resin(s) to be stabilized.

In a method which has proven successful in achieving an inventive effect, the content of β-diketone or salts of a β-diketone or their mixtures is less than about 0.1% by weight in an inventive stabilizer composition. By way of example, advantages can be achieved here if the content of β-diketone or salts of a β-diketone or their mixtures is less than about 0.05% by weight, less than about 0.01% by weight or less than about 0.005% by weight, based on the entire stabilizer composition. By way of example, the content of β-diketone or salts of a β-diketone or their mixtures is less than about 1000 ppm, in particular less than about 500 ppm or less than about 100 ppm or less than about 50 ppm in an inventive stabilizer composition.

For the purposes of the present invention, β-diketones are in particular compounds of the general formula I

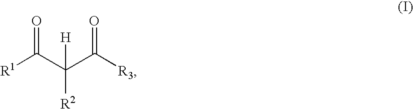

in which R¹ and R³ are in each case mutually independent and are an unsubstituted or substituted linear or branched alkyl or alkenyl group having from 1 to 30 carbon atoms, an unsubstituted or substituted aralkyl group having from 7 to 31 carbon atoms, an unsubstituted or substituted aryl or heteroaryl group having from 3 to 14 carbon atoms in the ring, or an unsubstituted or substituted cycloalkyl group having from 3 to 18 carbon atoms, or R¹ or R³ are in each case mutually dependent and can be O—R¹ or HN—R¹, and R² is O—R¹ or COOH or an unsubstituted or substituted linear or branched alkyl group having from 1 to 24 carbon atoms, or in each case R¹ or R³ or R¹ and R³ together with R² form an unsubstituted or substituted cycloaliphatic or heterocycloaliphatic ring in each case having, mutually independently, from 3 to 18 carbon atoms, or else their salts.

Corresponding compounds which are covered by the general formula I and whose content should for the purposes of the present invention be at or below the abovementioned upper limits are propionylacetylmethane, butyroylacetylmethane, pentanoylacetylmethane, hexanoylacetylmethane, heptanoylacetylmethane, triacetylmethane, benzoylacetylmethane, dimedone, acetyltetralone, palmitoyltetralone, stearoyltetralone, benzoyltetralone, acetylacetone, 2-acetylcyclohexanone, 2-benzoylcyclohexanone, 2-acetylcyclohexanone-1,3-dione, bis(4-methylbenzoyl)methane, bis(2-hydroxybenzoyl)methane, tribenzoylmethane, diacetylbenzoylmethane, stearoylbenzoylmethane, palmitoylbenzoylmethane, diacetylbenzoylmethane, dibenzoylmethane, 4-methoxybenzoylbenzoylmethane, bis(3,4-methylenedioxybenzoyl)methane, benzoylacetyloctylmethane, benzoylacetylphenylmethane, stearoyl-4-methoxybenzoylmethane, bis(4-tert-butylbenzoyl)methane, benzoylacetylethylmethane, benzoyltrifluoroacetylmethane, distearoylmethane, stearoylacetylmethane, palmitoylacetylmethane, lauroylacetylmethane, benzoylformylmethane, acetylformylmethylmethane, benzoylacetylphenylmethane, bis(cyclohexanoyl(2))methane and the like.

Salts of these compounds are in particular the salts with alkali metals, with alkaline earth metals or with appropriate transition metals. Examples of appropriate salts are the salts of the abovementioned compounds with Li, Na, K, Ba, Ca, Mg, Zn, Zr, Ti, Sn or Al.

For the purposes of another embodiment of the present invention it has been found advantageous for an inventive stabilizer composition to be in essence free from β-diketone or salts of a β-diketone or their mixtures. “Free from β-diketone or salts of a β-diketone or their mixtures” means for the purposes of the present invention a condition in which no β-diketones or salts of a β-diketone, not even very small amounts, are added to the stabilizer composition. The content of β-diketones or salts of a β-diketone or their mixtures here is at most by way of example of the order of magnitude of minor contaminants or below the achievable detection limits of analysis methods commonly used at the time of the invention.

If an inventive stabilizer composition comprises a component C, the content, based on the entire stabilizer composition, of components A, B and C in the stabilizer composition is from about 0.5 to about 80% by weight. The content of components A, B and C in such an instance is preferably from about 1 to about 50% by weight, for example from about 5 to about 20% by weight.

The proportion of component A in the stabilizer composition here is by way of example in the range from about 0.5 to about 30% by weight, by way of example in the range from about 1 to about 25% by weight or in particular in the range from about 5 to about 20% by weight or by way of example in the range from about 8 to about 11% by weight, based on the total weight of the stabilizer composition. It has likewise been found advantageous for the proportion of component A in the stabilizer composition to be in the range from about 0.5 to about 15% by weight, by way of example in the range from about 1 to about 10% by weight or in the range from about 1.5 to about 7% by weight or in the range from about 2 to about 5% by weight, based on the total weight of the stabilizer composition.

The proportion of component B in the stabilizer composition is by way of example in the range from about 0.1 to about 50% by weight, in particular in the range from about 1 to about 30% by weight, in particular in the range from about 2 to about 20% by weight, in particular in the range from about 2.5 to about 10% by weight, in particular in the range from about 4 to about 8% by weight, based on the total weight of the stabilizer composition.

The proportion of component C in the stabilizer composition is by way of example in the range from about 0.1 to about 20% by weight, by way of example in the range from about 1 to about 15%, by way of example in the range from about 4 to about 6%, based on the total weight of the stabilizer composition. Amounts likewise suitable are by way of example in the range from about 0.01 to about 12% by weight, by way of example in the range from about 0.05 to about 10% by weight, by way of example in the range from about 0.1 to about 8% by weight, by way of example in the range from about 0.15 to about 5% by weight, by way of example in the range from about 0.2 to about 3% by weight, based on the total weight of the stabilizer composition.

Although good stabilization results with surprisingly good weathering resistance are given simply by content preferably within the abovementioned limits of the abovementioned components A, B and optionally C in an inventive stabilizer composition, it has moreover been found advantageous with regard to an improvement in stabilizing effect for the inventive stabilizer composition to comprise a hydrotalcite or a mixture composed of two or more hydrotalcites.

For the purposes of the present invention, a type of hydrotalcite suitable here is in principle any type which with regard to processing properties and/or the stabilization of a halogen-containing polymer for the purposes of an inventive stabilizer composition at least exhibits no, or certainly in essence no, disadvantageous effect. Preference is moreover particularly given to those hydrotalcites which do not adversely affect the storage stability of an inventive stabilizer composition. By way of example, particularly suitable hydrotalcites are those described in the publications WO 96/02465 A1 (in particular pp. 3-7 and examples), EP 0 189 899 (in particular pp. 10-15, tables 2-10), DE 38 43 581 (in particular p. 4), U.S. Pat. No. 4,883,533 (in particular column 2-4, examples), EP 0 407 139 A2 (in particular pp. 2-3, examples), DE 40 31 818 A1 (in particular pp. 2-3), DE 41 10 835 A1 (in particular columns 2-5, examples) , DE 41 17 034 A1 (in particular pp. 2-6, examples), EP 0 522 810 A2 (in particular pp. 2-3), DE 44 39 934 A1 (in particular pp. 2-3, examples) and U.S. Pat. No. 5,352,723 (in particular columns 2-3, examples). The disclosure of the abovementioned publications, in particular the disclosure of the passages mentioned, is hereby expressly incorporated by way of reference, and the corresponding disclosure of the publications is part of the disclosure of the present text.

The invention has shown here that in particular a content of hydrotalcite within relatively narrow limits which is within the range from about 0.05 to about 0.25 phr, based on the amount of halogen-containing polymers to be stabilized provides support for the inventive content of components A and B or A, B and C with respect to particularly good processability and good stabilization results. For the purposes of one preferred embodiment of the present invention, an inventive stabilizer composition therefore comprises an amount of from about 0.08 to about 1.8 phr, for example an amount of from about 0.1 to about 0.15 phr, of a hydrotalcite or a mixture composed of two or more hydrotalcites.

It has moreover been found advantageous for an inventive stabilizer composition to comprise at least one zinc salt, preferably a zinc salt of an organic carboxylic acid or a mixture composed of two or more thereof. The invention moreover permits an inventive stabilizer composition to comprise a mixture composed of at least one zinc salt of an organic carboxylic acid having 16 carbon atoms or more and composed of at least one zinc salt of an organic carboxylic acid having fewer than 16 carbon atoms.

Examples of suitable organic carboxylic acids are caproic acid, caprylic acid, capric acid, lauric acid, myristic acid, enanthic acid, octanoic acid, neodecanoic acid, 2-ethylhexanoic acid, pelargonic acid, decanoic acid, undecanoic acid, dodecanoic acid, tridecanoic acid, palmitic acid, laurylic acid, linoleic acid, linolenic acid, erucic acid, isostearic acid, stearic acid, 12-hydroxystearic acid, 9,10-dihydroxystearic acid, oleic acid, 3,6-dioxaheptanoic acid, 3,6,9-trioxadecanoic acid or behenic acid.

If an inventive stabilizer composition comprises a mixture composed of at least one zinc salt of an organic carboxylic acid having 16 carbon atoms or more and of at least one zinc salt of an organic carboxylic acid having fewer than 16 carbon atoms, the ratio of Zn salt or mixture composed of two or more Zn salts of carboxylic acids having 16 carbon atoms or more to Zn salt or to a mixture composed of two or more Zn salts of carboxylic acids having fewer than 16 carbon atoms is advantageously from about 1:100 to about 100:1, in particular from about 1:10 to about 10:1.

For the purposes of one preferred embodiment of the present invention, an inventive stabilizer composition comprises a mixture composed of zinc stearate and at least of one other organic zinc salt, where the at least one other organic Zn salt is by way of example a Zn salt of an organic carboxylic acid having fewer than 16 carbon atoms or a zinc salt of a substituted carboxylic acid, in particular of a carboxylic acid substituted with hydroxy groups. By way of example, suitable mixtures here are the mixtures of Zn stearate and Zn caprylate or of Zn stearate and Zn 12-hydroxystearate.

The proportion of a mixture composed of two or more of the abovementioned Zn salts in the inventive stabilizer composition is preferably from about 0.1 to about 5 phr, based on the amount of the halogen-containing polymers to be stabilized, by way of example from about 0.2 to about 2 phr or from about 0.8 to about 1.2 phr.

It has moreover been found advantageous for the processing properties and stabilization properties of the present inventive stabilizer composition for the stabilizer composition to comprise a triglyceride. Suitable triglycerides in this connection are any of the triglycerides at least which do not adversely affect the processing properties of a polymer composition which comprises an inventive stabilizer composition.

Examples of suitable triglycerides are natural or synthetic fats. The invention has shown that the use of triglycerides together with the abovementioned compounds in an inventive stabilizer composition leads to an improvement in the surface structure during extrusion. Other advantageous effects are good hydrolysis resistance, fast gelling, ability to bind large amounts of fillers, lack of plate-out effect.

Particularly suitable materials here are glycerol stearates such as purified bovine tallow, hydrogenated bovine tallow, purified fish oil or hydrogenated fish oil or glycerol tri(12-hydroxystearates), such as hydrogenated castor oil or mixtures composed of two or more of the compounds mentioned. Hydrogenated bovine tallow or hydrogenated castor oil are particularly suitable.

The inventive stabilizer combination can also comprise at least one other additive or a mixture composed of two or more of the additives mentioned. The total amount which can be present according to the invention of the additives mentioned below is from about 2 to about 99.9% by weight, based on the entire stabilizer composition.

Examples of additives likewise suitable are other amino alcohols. For the purposes of the present invention, suitable amino alcohols are in principle any of the compounds which have at least one OH group and one primary, secondary or tertiary amino group or a combination composed of two or more of the amino groups mentioned. For the purposes of the present invention, either solid or liquid amino alcohols are in principle suitable as constituent of the inventive stabilizer compositions. However, for the purposes of the present invention, the proportion of liquid amino alcohols is by way of example selected in such a way that the entire stabilizer composition in essence is a solid.

For the purposes of one preferred embodiment of the present invention, amino alcohols that can be used for the purposes of the present invention have a melting point above about 30° C., in particular above about 50° C. Examples of suitable amino alcohols are mono- or polyhydroxy compounds which are based on linear or branched, saturated or unsaturated aliphatic mono- or polyamines.

Examples of compounds suitable here are derivatives bearing OH groups of primary mono- or polyamino compounds having from 2 to about 40, by way of example from 6 to about 20, carbon atoms. By way of example, these are corresponding derivatives bearing OH groups of ethylamine, of n-propylamine, of isopropylamine, of n-propylamine, of sec-propylamine, of tert-butylamine, of 1-aminoisobutane, of substituted amines having from two to about 20 carbon atoms, such as 2-(N,N-dimethylamino)-1-aminoethane. Examples of suitable derivatives bearing OH groups of diamines are those based on diamines whose molar mass is from about 32 to about 200 g/mol, where the corresponding diamines have at least two primary, two secondary or one primary and one secondary amino group(s). Examples of these are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexylmorpholine, dimethylcyclohexylamine, dimorpholinodiethyl ether, 1,4-diazabicyclo[2.2.2]octane, 1 -azabicyclo[3.3.0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylaminopropyl)urea, N,N′-dimethylpiperazine, 1,2-dimethylimidazole or di(4-N,N-dimethylaminocyclohexyl)methane.

Aliphatic amino alcohols having from 2 to about 40, preferably from 6 to about 20, carbon atoms are particularly suitable, examples being 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, aromatic-aliphatic or aromatic-cycloaliphatic amino alcohols having from 6 to about 20 carbon atoms, where the aromatic structures that can be used comprise heterocyclic or isocyclic ring systems, e.g. naphthalene derivatives or in particular benzene derivatives, e.g. 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, or else mixtures composed of two or more of these compounds.

For the purposes of the present invention, additives likewise suitable are compounds having a structural element of the general formula III

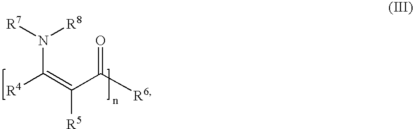

in which n is a number from 1 to 100 000, the radicals R⁷, R⁸, R⁴ and R⁵ are in each case mutually independent and are hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms or an unsubstituted or substituted aryl radical having from 6 to 44 carbon atoms or an unsubstituted or substituted aralkyl radical having from 7 to 44 carbon atoms, or the radical R⁴ is an unsubstituted or substituted acyl radical having from 2 to 44 carbon atoms, or the radicals R⁴ and R⁵ have been bonded to give an aromatic or heterocyclic system, and in which the radical R⁶ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether radical or, respectively, thioether radical having from 1 to 20 O or, respectively, S atoms or O and, respectively, S atoms or a polymer which has bonding by way of O, S, NH, NR⁴ or CH₂C(O) to the structural element shown in parentheses, or the radical R⁶ has bonding to the radical R⁴ in such a way that the overall result is an unsubstituted or substituted, saturated or unsaturated heterocyclic ring system having from 4 to 24 carbon atoms, or a mixture composed of two or more compounds of the general formula III.

For the purposes of one preferred embodiment of the present invention, a compound based on an α,β-unsaturated β-aminocarboxylic acid, in particular a compound based on β-aminocrotonic acid, is used as compound of the general formula III. The esters or thioesters of the corresponding aminocarboxylic acids with monohydric or polyhydric alcohols or mercaptans are particularly suitable here.

A precise description of the compounds of the general formula III that can be used for the purposes of the present invention is found in WO 02/068526, on pages 7 to 10, and that publication, and also the corresponding disclosure, are expressly incorporated herein by way of reference, and the disclosure is considered to be part of the disclosure of the present text.

Compounds likewise suitable as additives are those having at least one mercapto-functional sp²-hybridized carbon atom, these being as described in WO 02/068526 on pages 10 to 11. That publication, and also the corresponding disclosure, are expressly incorporated herein by way of reference, and the disclosure is considered to be part of the disclosure of the present text.

An inventive stabilizer composition can moreover comprise the fillers described in “Handbook of PVC Formulating”, E. J. Wickson, John Wiley & Sons, Inc., 1993, on pages 393-449, an example being chalk, or the reinforcing agents described in “Taschenbuch der Kunststoffadditive” [Plastics Additives Handbook], R. Gachter/H. Müller, Carl Hanser Verlag, 1990, pages 549-615, or pigments.

Salts of halogen-containing oxy-acids, in particular perchlorate, are likewise suitable as additives. Examples of suitable perchlorates are those of the general formula M(ClO₄)ₙ, where M is Li, Na, K, Mg, Ca, Sr, Zn, Al, La or Ce. The index n corresponds to the valency of M and is the number 1, 2 or 3. The perchlorate salts mentioned can take the form of a complex with alcohols (polyols, cyclodextrins) or with ether alcohols or with ester alcohols. The partial esters of polyols are among the ester alcohols. In the case of polyhydric alcohols or polyols, it is also possible to use their dimers, trimers, oligomers and polymers, e.g. di-, tri-, tetra- and polyglycols and also di-, tri- and tetrapentaerythritol or polyvinyl alcohol in various degrees of polymerization and of hydrolysis. Preferred suitable partial esters of polyols are glycerol monoethers and glycerol monothioethers. Sugar alcohols or thio sugars are likewise suitable.

The perchlorate salts here can be used in various commonly encountered supply forms, for example as salt or aqueous solution, absorbed onto a suitable carrier material, such as PVC, calcium silicate, zeolites, calcium hydroxide, calcium oxide or hydrotalcites, or bound via chemical reaction into a hydrotalcite. With regard to perchlorate compounds absorbed onto calcium oxide or onto calcium hydroxide, DE 101 24 734 A1 is expressly incorporated herein by way of reference, the disclosure of that publication with regard to perchlorates on carriers being considered to be part of the disclosure of the present text.

Examples of additives likewise suitable are basic calcium aluminum hydroxyphosphites of the general formula (IV)

CaₓAl₂(OH)_{2(x+3-y)}(HPO₃)_{y}*m H₂O (IV),

in which 2≦x≦12, (2x+5)/2>y>0 and 0≦m≦12. Examples of compounds of the general formula (IV) are described in DE 41 06 411 A. DE-A-3941902 describes other basic calcium aluminum hydroxyphosphites. The disclosure of the publications mentioned with respect to basic calcium aluminum hydroxyphosphites is expressly incorporated herein by way of reference. The disclosure is considered to be part of the disclosure of the present text.

Other additives suitable for the purposes of the inventive stabilizer compositions are basic calcium aluminum hydroxycarboxylates of the general formula V

CaₓAl₂(OH)_{[(2X+6)-y]}A_{y/n}ⁿ⁻*m H₂O (V),

in which 2≦x≦12,(2x+5)/2>y>0, 0≦m≦12and 1≦n≦8,and Aⁿ⁻ is an aliphatic saturated, unsaturated, straight-chain or branched mono- or polyvalent carboxylic anion having from 1 to 22 carbon atoms or is an aromatic or heteroaromatic mono- or polyvalent carboxylic anion having from 6 to 20 carbon atoms.

By way of example, the carboxylic anion Aⁿ⁻ in the general formula (V) can be selected from anions of malonic, succinic, adipic, fumaric, maleic, phthalic, isophthalic, terephthalic, pyridinic, benzoic, salicylic, tartronic, malic, tartaric, acetonedicarboxylic, oxalacetic, aconitic and citric acid. Anions of fumaric and phthalic acid are preferably used, and fumarates are particularly preferably used.

By way of example, DE 41 06 404 A discloses compounds of the general formula (V). Other calcium aluminum hydroxycarboxylates are described in DE 40 02 988 A, and the disclosure of these publications with respect to the calcium aluminum hydroxycarboxylates mentioned is expressly incorporated herein by way of reference, and their disclosure is considered to be part of the disclosure of the present text.

Other suitable additives for the purposes of the inventive stabilizer composition are polyols. Examples of suitable polyols are pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, Lycasin, mannitol, lactose, leucrose, palatinitol, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

Examples of additives likewise suitable are epoxy compounds. Examples of these epoxy compounds are epoxidized soy oil, epoxidized olive oil, epoxidized linseed oil, epoxidized castor oil, epoxidized peanut oil, epoxidized maize oil, epoxidized cottonseed oil, and also glycidyl compounds. Particularly suitable glycidyl compounds are the glycidyl compounds described on pages 20 to 22 of WO 02/068526. The disclosure of the publication mentioned with respect to the glycidyl compounds is expressly incorporated herein by way of reference and is considered to be part of the disclosure of the present text.

Particularly suitable epoxy compounds are described by way of example in EP-A 1 046 668 on pages 3 to 5, and the disclosure present in that reference is expressly incorporated herein by way of reference and is considered to be part of the disclosure of the present text.

Examples of additives likewise suitable. are zeolites, which can be described via the general formula Mₓⁿ[(AlO₂)ₓ(SiO₂)_{y}]*m H₂O, in which n is the charge on the cation M (e.g. alkali metal or alkaline earth metal), and 0.8≦x, y≦15 and 0≦m≦300.

Examples of additives likewise suitable are the sterically hindered amines described on pages 7 to 27 of EP-A 1 046 668. The sterically hindered amines disclosed in that reference are expressly incorporated herein by way of reference, and the compounds mentioned in that reference are considered to be part of the disclosure of the present text.

The uracils and amino uracils mentioned by way of example in EP 1 046 668 are other suitable additives. The disclosure concerning amino uracils in the publication mentioned is considered to be part of the disclosure of the present text.

Additives likewise suitable are amino acids and their alkali metal salts and their alkaline earth metal salts.

Additives likewise suitable are hydrocalumites of the general formula AlCaₓ(OH)₂ₓ₊₃ * mH₂O; x=from 1 to 4; m=from 0 to 8, these being described by way of example in DE 41 03 881. The publication mentioned and its disclosure with respect to the hydrocalumites mentioned are expressly incorporated herein by way of reference and the disclosure is considered to be part of the disclosure of the present text.

An inventive stabilizer composition can moreover also comprise, as additive, an organotin compound or a mixture composed of two or more organotin compounds. Examples of suitable organotin compounds are methyltin tris-(isooctyl thioglycolate), methyltin tris(isooctyl 3-mercaptopropionate), methyltin tris(isodecyl thioglycolate), dimethyltin bis(isooctyl thioglycolate), dibutyltin bis(isooctyl thioglycolate), monobutyltin tris(isooctyl thioglycolate), dioctyltin bis(isooctyl thioglycolate), monooctyltin tris(isooctyl thioglycolate) or dimethyl-tin bis(2-ethylhexyl β-mercaptopropionate).

For the purposes of the inventive stabilizer compositions it is moreover possible to use the organotin compounds which are mentioned, and whose production is described, in EP-A 0 742 259, on pages 18 to 29. The abovementioned disclosure is expressly incorporated herein by way of reference, and the compounds mentioned in that disclosure and their preparation are considered to be part of the disclosure of the present text. Additives likewise suitable are the latent mercaptans described in EP 0 742 259 A1 and in EP 1 201 706 A1, and also cyanoacetylureas of DE 299 24 285 U1, and the abovementioned disclosure passages are expressly incorporated herein by way of reference and the compounds mentioned in those passages and their preparation are considered to be part of the disclosure of the present text.

For the purposes of another embodiment of the present invention, an inventive stabilizer composition can comprise organic phosphite esters having from 1 to 3 organic radicals which are identical, or a pair of which are identical, or which are different. Examples of suitable organic radicals are linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyldi(octylphenyl), tris(2-ethylhexyl), tritolyl, tris(2-cyclohexylphenyl), tri-α-naphthyl, tris(phenylphenyl), tris(2-phenylethyl), tris-(dimethylphenyl), tricresyl or tris(p-nonylphenyl) phosphite or tristearyl sorbitol triphosphite or a mixture composed of two or more thereof.

An inventive stabilizer composition can moreover comprise lubricants, such as montan wax, fatty acid esters, polyethylene waxes, amide waxes, chloroparaffins or alkaline earth metal soaps. Lubricants that can be used as additives are moreover also described in “Kunststoffadditive” [Plastics additives], R. Gächter and H. Müller, Carl Hanser Verlag, 3rd edition, 1989, pp. 478-488. Examples of additives likewise suitable are the fatty ketones described in DE 4,204,887, and also the silicone-based lubricants mentioned by way of example in EP-A 0 259 783, or the combinations thereof mentioned in EP-A 0 259 783. The documents mentioned are expressly incorporated herein by way of reference and their disclosure relating to lubricants is considered to be part of the disclosure of the present text.

Organic plasticizers are also suitable as additives for stabilizer compositions of the present invention.

Examples of suitable corresponding plasticizers are the compounds mentioned above. for the purposes of the description of the solvents and belonging to the phthalic ester group, e.g. dimethyl, diethyl, dibutyl, dihexyl, di-2-ethylhexyl, di-n-octyl, diiso-octyl, diisononyl, diisodecyl, dicyclohexyl, dimethylcyclohexyl, dimethyl glycol, dibutyl glycol, benzyl butyl phthalate or diphenyl phthalate, and also mixtures of phthalates, for example mixtures of alkyl phthalates having from 7 to 9 or from 9 to 11 carbon atoms in the ester alcohol or mixtures of alkyl phthalates having from 6 to 10 and from 8 to 10 carbon atoms in the ester alcohol. For the purposes of the present invention, particularly suitable compounds here are dibutyl phthalate, dihexyl phthalate, di-2-ethylhexyl phthalate, di-n-octyl phthalate, diisooctyl phthalate, diisononyl phthalate, diisodecyl phthalate, diisotridecyl phthalate, and benzyl butyl phthalate, and also the mixtures mentioned of alkyl phthalates.

Other suitable plasticizers are the esters of aliphatic dicarboxylic acids, in particular the esters of adipic, azelaic or sebacic acid or a mixture composed of two or more thereof. Examples of these plasticizers are di-2-ethylhexyl adipate, diisooctyl adipate, diisononyl adipate, diisodecyl adipate, benzyl butyl adipate, benzyl octyl adipate, di-2-ethylhexyl azelate, di-2-ethylhexyl sebacate and diiso-decyl sebacate. For the purposes of another embodiment of the present invention, preference is given to di-2-ethylhexyl acetate and diisooctyl adipate.

Other suitable plasticizers are trimellitic esters, such as tri-2-ethylhexyl trimellitate, triisotridecyl trimellitate, triisooctyl trimellitate, and also trimellitic esters having from 6 to 8, from 6 to 10, from 7 to 9 or from 9 to 11 carbon atoms in the ester group or a mixture composed of two or more of the compounds mentioned.

Examples of plasticizers likewise suitable are the polymeric plasticizers described in “Kunststoffadditive” [Plastics additives], R. Gächter and H. Müller, Carl Hanser Verlag, 3rd edition, 1989, chapter 5.9.6, pages 412-415, or “PVC Technology”, W. V. Titow, 4th edition, Elsevier Publishers, 1984, pages 165-170. Examples of the starting materials most commonly used for the preparation of polyester plasticizers are dicarboxylic acids, such as adipic, phthalic, azelaic or sebacic acid, or else diols, such as 1,2-propanediol, 1,3-butanediol, 1,4-butanediol, 1,6-hexanediol, neopentyl glycol or diethylene glycol or a mixture composed of two or more thereof.

Other suitable plasticizers are the phosphoric esters described in “Taschenbuch der Kunststoffadditive” [Plastics additives handbook], chapter 5.9.5, pp. 408-412. Examples of suitable phosphoric esters are tributyl phosphate, tri-2-ethylbutyl phosphate, tri-2-ethylhexyl phosphate, trichloroethyl phosphate, 2-ethylhexyl diphenyl phosphate, triphenyl phosphate, tricresyl phosphate or trixylyl phosphate or a mixture composed of two or more thereof.

Other suitable plasticizers are chlorinated hydrocarbons (paraffins) or the hydrocarbons described in “Kunststoffadditive” [Plastics additives], R. Gächter and H. Müller, Carl Hanser Verlag, 3rd edition, 1989, chapter 5.9.14.2, pp. 422-425 and chapter 5.9.14.1, p. 422.

For the purposes of another embodiment of the present invention, the inventive stabilizer compositions can comprise antioxidants, UV absorbers and light stabilizers or blowing agents. Suitable antioxidants are described by way of example on pages 33 to 35 of EP-A 1 046 668. Pages 35 and 36 of that publication mention suitable UV absorbers and light stabilizers. The two references are expressly incorporated herein by way of reference, and these references are considered to be part of the present text.

Examples of suitable blowing agents are organic azo compounds and organic hydrazo compounds, tetrazoles, oxazines, isatic anhydride, salts of citric acid, e.g. ammonium citrate, and also soda and sodium bicarbonate. By way of example, particularly suitable compounds are ammonium citrate, azodicarbonamide or sodium bicarbonate or a mixture composed of two or more thereof.

An inventive stabilizer composition can moreover also comprise impact modifiers and processing aids, gelling agents, antistatic agents, biocides, metal deactivators, optical brighteners, flame retardants, and also antifogging compounds. Suitable compounds of these classes of compound are described by way of example in “Kunststoff Additive” [Plastics additives], R. Keβler and H. Müller, Carl Hanser Verlag, 3rd edition, 1989, and also in “Handbook of PVC Formulating”, E. J. Wilson, J. Wiley & Sons, 1993.

An inventive stabilizer composition can in principle be prepared in any desired manner via mixing of the individual components.

The inventive stabilizer compositions are suitable for the stabilization of halogen-containing polymers.

Examples of these halogen-containing polymers are polymers of vinyl chloride, vinyl resins which contain vinyl chloride units in the main polymer chain, copolymers of vinyl chloride and of vinyl esters of aliphatic acids, in particular vinyl acetate, copolymers of vinyl chloride with esters of acrylic and methacrylic acid or acrylonitrile or a mixture composed of two or more thereof, copolymers of vinyl chloride with diene compounds or with unsaturated dicarboxylic acids or with their anhydrides, e.g. copolymers of vinyl chloride with diethyl maleate, diethyl fumarate, or maleic anhydride, post-chlorinated polymers and copolymers of vinyl chloride, copolymers of vinyl chloride and of vinylidene chloride with unsaturated aldehydes, ketones, and other compounds, such as acrolein, crotonaldehyde, vinyl methyl ketone, vinyl methyl ether, vinyl isobutyl ether and the like, polymers and copolymers of vinylidene chloride with vinyl chloride and with the other polymerizable compounds mentioned above, polymers of vinyl chloroacetate and of dichlorodivinyl ether, chlorinated polymers of vinyl acetate, chlorinated polymeric esters of acrylic acid and of α-substituted acrylic acids, chlorinated polystyrenes, such as polydichlorostyrene, chlorinated polymers of ethylene, polymers and post-chlorinated polymers of chlorobutadiene and their copolymers with vinyl chloride, and also mixtures composed of two or more of the abovementioned polymers or polymer mixtures, which comprise one or more of the abovementioned polymers. For the purposes of one preferred embodiment of the present invention, the inventive stabilizer compositions are used for the production of moldings composed of UPVC, e.g. of window profiles, of engineering profiles, or of pipes and sheets.

Materials likewise suitable for stabilization with the inventive stabilizer compositions are the graft polymers of PVC with EVA, ABS or MBS. Other preferred substrates for these graft copolymers are the abovementioned homo- and copolymers, in particular mixtures of vinyl chloride homopolymers with other thermoplastic or elastomeric polymers, in particular blends with ABS, MBS, NBR, SAN, EVA, CPE, MBAS, PAA (polyalkyl acrylate), PAMA (polyalkyl methacrylate), EPDM, or with polyamides or with polylactones.

Materials likewise suitable for stabilization with the inventive stabilizer compositions are mixtures of halogenated and non-halogenated polymers, for example mixtures of the abovementioned non-halogenated polymers with PVC, in particular mixtures of polyurethanes and PVC.

The inventive stabilizer compositions can also be used to stabilize recycled material from chlorine-containing polymers, and in principle here any of the recycled materials from the abovementioned, halogenated polymers is suitable for this purpose. An example of a material suitable for the purposes of the present invention is recycled PVC material.

The inventive stabilizer composition is preferably used for polyvinyl chloride (PVC) as halogen-containing thermoplastic resin. By way of example, it is used for UPVC (rigid PVC). The term polyvinyl chloride used herein encompasses commonly used homo- and copolymers of vinyl chloride, and also blends of these polyvinyl chloride compounds with other polymer compositions. Polymers of this type may have been prepared in any desired manner, for example via suspension polymerization, emulsion polymerization, or block polymerization. Their K value can be from 50 to 100, for example.

It has been found that use of an inventive stabilizer combination can in particular produce, for external applications, moldings composed of UPVC which exhibit unexpectedly high weathering resistance and unexpectedly high heat resistance, and which also have excellent processing properties.

The present invention therefore also provides a polymer composition comprising a stabilizer composition, a dye or a pigment or both and at least one polymer, comprising as stabilizer composition at least one stabilizing calcium compound, for example a stabilizing calcium salt, or a mixture composed of two or more such compounds and comprising as polymer a halogen-containing thermoplastic resin or a mixture composed of two or more halogen-containing thermoplastic resins where the polymer composition comprises less than 0.1 phr of β-diketone or salts of a β-diketone or their mixtures.

By way of example, the content of β-diketone or of salts of a β-diketone or of their mixtures is less than 0.05 phr or less than 0.01 phr or less than 0.005 phr or less than 0.001 phr or less than 0.005 phr or less than 0.001 phr in an inventive polymer composition. Other polymer compositions suitable for the purposes of the present invention are those whose content of β-diketone or of salts of a β-diketone or of their mixtures, based on the weight of the polymer composition, is about 0.1% by weight or less, for example less than about 0.05% by weight, less than about 0.01% by weight or less than about 0.005% by weight, based on the entire stabilizer composition. By way of example, the content of β-diketone or of salts of a β-diketone or of their mixtures can be less than about 1000 ppm, in particular less than about 500 ppm or less than about 100 ppm or less than about 50 ppm in an inventive polymer composition.

An inventive polymer composition comprises an amount which is preferably from 0.01 to 2 phr of a stabilizing calcium salt or of a mixture composed of two or more of these salts as component A, based on the halogen-containing resin. An inventive polymer composition comprises an amount which is preferably from 0.01 to 2 phr of dyes or pigments or of their mixture as component B, based on the halogen-containing resin. An inventive polymer composition comprises an amount which is preferably from 0.01 to 2 phr of an isocyanurate bearing hydroxy groups or of a mixture composed of two or more of these compounds as component C, based on the halogen-containing resin.

An inventive polymer composition preferably comprises a hydrotalcite or a mixture composed of two or more hydrotalcites. The invention therefore likewise encompasses polymer compositions which comprise a zinc salt or comprise a mixture composed of two or more zinc salts. The invention moreover encompasses polymer compositions which comprise a polyol, and also encompasses polymer compositions which are in essence free from β-diketones or from salts of β-diketones or from their mixtures.

With respect to a polymer composition of the present invention, the statements made above in relation to the stabilizer composition are also applicable to the stabilizer components present in that polymer composition. A fundamental difference between the polymer compositions of the present invention and the inventive stabilizer compositions is that the stabilizer compositions comprise no polymer. In other respects, the properties of the stabilizer compositions present in the polymer composition and of the inventive stabilizer compositions are identical, and the abovementioned statements with regard to the stabilizer compositions are therefore also applicable to the stabilizer components present in the polymer compositions.

For the purposes of one preferred embodiment of the present invention, an inventive polymer composition comprises an amount of from about 0.1 to 20 phr, in particular from about 0.5 to about 15 phr, or from about 1 to about 12 phr, or from about 1.5 to 5 phr of the inventive stabilizer composition. The ideal amount for a particular instance also depends here on the lubricants used. The unit phr is “per hundred resin” and therefore relates to parts by weight per 100 parts by weight of polymer. Examples of suitable amounts used are within the range of about 2-3 phr and, respectively, 3-4 phr, if a proportion of processing aids is included in the calculation.

An inventive polymer composition preferably comprises, as halogenated polymer, at least a proportion of PVC, the proportion of PVC here in particular being at least about 20% by weight, preferably at least about 50% by weight, for example at least about 80% by weight or at least about 90% by weight.

The mixing of polymers or of polymers and of the inventive stabilizer composition for the preparation of the inventive polymer compositions can in principle take place at any desired juncture prior to or during the processing of the polymer. By way of example, the stabilizer composition can be admixed with the polymer present in the form of powder or of pellets, prior to processing. However, it is similarly possible to add the stabilizer composition to the polymer or to the polymers in a softened or molten condition, for example during processing in an extruder.

The present invention therefore also provides a process for the preparation of a polymer composition, comprising a stabilizer composition and at least one polymer, by mixing with one another
(a) at least one stabilizing calcium compound or one mixture composed of two or more stabilizing calcium compounds as component A and
(b) at least one dye or one pigment or one mixture composed of two or more thereof as component B and
(c) at least one isocyanurate bearing hydroxy groups or one mixture composed of two or more such compounds as component C, and
(d) at least one halogen-containing thermoplastic resin or one mixture composed of two or more halogen-containing thermoplastic resins,
   where the polymer composition after mixing comprises less than 0.1 phr of β-diketone or salts of a β-diketone or their mixtures.

The inventive stabilizer composition can take any desired physical form, e.g. powder mixture form, compressed-granule form, spray-granule form, or microgranule-form, flake form or pastille form. These forms of the product can either be produced in the form of granules from pulverulent mixtures by compression and/or heat, and/or by adding granulation auxiliaries, or can be molded by cooling and, respectively, spraying of melts of the inventive composition to give flakes, pastilles or prills. For preparation of halogen-containing resin compositions, the individual substances can be added directly or in the form of a mixture in the abovementioned forms of the product prior to or during processing. The halogen-containing thermoplastic resin composition can then be molded in a manner known per se to give moldings.

An inventive polymer composition can be brought in a known manner to a desired shape. Examples of suitable processes are calendering, extrusion, injection molding, sintering, extrusion blow molding or the plastisol process. By way of example, an inventive polymer composition can also be used for the production of foams. In principle, the inventive polymer composition is suitable for the production of rigid PVC or of flexible PVC.

An inventive polymer composition can be processed to give moldings. The present invention therefore also provides moldings for use in the weathered outdoor sector, at least comprising an inventive stabilizer composition or an inventive polymer composition.

For the purposes of the present invention, the term “molding” in principle encompasses any of the three-dimensional structures that can be produced from an inventive polymer composition. For the purposes of the present invention, examples of products encompassed by the term “molding” are wire sheathing, automobile components, such as the automobile components used in the engine compartment or used on the external areas, cable insulation, cable sheathing, decorative foils, agricultural foils, hoses, sealing profiles, office foils, hollow products (bottles), packaging foils (thermoforming foils), blown foils, pipes, foams, heavy-duty profiles (window frames), lightweight-wall profiles, construction profiles, sidings, fittings, foam sheets and other sheets, coextrudates with recycled core, housings for electrical apparatuses or machines, for example computers or household devices, in particular for use in the weathered outdoor sector. Other examples of moldings that can be produced from an inventive polymer composition are synthetic leather, floor coverings, textile coatings, wallpapers, coil coatings, or underbody protection for motor vehicles.

The present invention also provides the use of an inventive stabilizer composition or of an inventively prepared stabilizer composition or of an inventive polymer composition in the production of polymeric moldings or of surface-coating compositions for use in the weathered outdoor sector.

The invention in particular provides the use of a stabilizer composition for the stabilization of a halogen-containing thermoplastic resin or of a mixture composed of two or more halogen-containing thermoplastic resins, where the stabilizer composition comprises at least
(a) one stabilizing calcium compound or one mixture composed of two or more such compounds as component A and
(b) at least one dye or one pigment or one mixture composed of two or more thereof as component B and
(c) at least one isocyanurate bearing hydroxy groups or one mixture composed of two or more such compounds as component C,
   where the content of β-diketone or salts of a β-diketone or their mixtures is less than 0.1% by weight in the stabilizer composition.

Examples are used below for further illustration of the invention.

### EXAMPLES

3 PVC test specimens were produced using the formulations below:

TABLE 1
Composition of test specimens 1, 2 and 3

| | 1 | 2 | 3 |
|---|---|---|---|
| SPVC (K value = 68) | 100 | 100 | 100 |
| Chalk | 6 | 6 | 6 |
| Carbon black pigment | 0.6 | 0.6 | 0.6 |
| Pb stabilizer | 4.45 | — | — |
| Glycerol tristearate | — | 0.5 | 0.5 |
| Ca Al hydroxyphosphite | — | 0.1 | 0.1 |
| Zn stearate | — | 1.1 | 1.1 |
| Ca acetylacetonate | — | 0.1 | — |
| Benzoylstearoylmethane | — | 0.3 | — |
| PE wax | — | 0.2 | 0.2 |
| Ca(OH)₂ | — | 0.32 | 0.32 |
| THEIC | — | 0.18 | 0.18 |
| Irganox 1076 | — | 0.09 | 0.09 |
| process aid | 1.5 | 0.5 | 0.5 |

The test specimens were then subjected to weathering using the following conditions:
Black standard temperature: 50° C.±3° C.
Wetting method: 4 h wet/4 h dry
Lamp type (295-400 nm): UVA-340

The behavior of the test specimens under the abovementioned conditions was as follows:

TABLE 2
Test results for test specimens 1, 2 and 3:

| | | | Complete |
|---|---|---|---|
| Test specimen | Colorfast | Marked bleaching | bleaching |
| 1 | 500 h | 1000 h | 1000 h |
| 2 | 500 h | 1000 h | 1500 h |
| 3 | 1500 h | 2000 h | 2500 h |

1. A stabilizer composition for the stabilization of one or more halogen-containing thermoplastic resins, comprising
(a) a stabilizing calcium compound or a mixture composed of two or more stabilizing calcium compounds as component A and
(b) at least one dye, at least one pigment or a mixture thereof as component B, where the at least one dye, the at least one pigment, or the mixture thereof gives a halogen-containing thermoplastic resin the chromaticity coordinate L≦95, wherein a=0±>1 or b=0±>1 or a=0±>1 and b=0±>1 and
(c) at least one isocyanurate bearing hydroxy groups as component C,
wherein, based on the entire stabilizer composition, the content of β-diketone, β-diketone salts, or mixtures thereof is less than 0.1% by weight in the stabilizer composition.

2. The stabilizer composition as claimed in claim 1, wherein, based on the entire stabilizer composition, the content of β-diketone, β-diketone salts, or mixtures thereof is less than 0.01% by weight.

3. The stabilizer composition as claimed in claim 1, said composition being substantially free of β-diketone, β-diketone salts, or mixtures thereof.

4. The stabilizer composition as claimed in claim 1, further comprising one or more additives.

5. The stabilizer composition as claimed in claim 1, further comprising a zinc salt.

6. The stabilizer composition as claimed in claim 1, further comprising a polyol.

7. A polymer composition, comprising one or more halogen-containing thermoplastic resins and a stabilizer composition comprising (a) at least one dye, at least one pigment or a mixture thereof, where the at least one dye, the at least one pigment, or the mixture thereof gives a halogen-containing thermoplastic resin the chromaticity coordinate L<95, wherein a=0±>1 or b=0±>1 or a=0±>1 and b=0±>1, (b) at least one stabilizing calcium compound and (c) at least one isocyanurate bearing hydroxy groups, wherein the polymer composition comprises less than 0.1 phr of β-diketone, β-diketone salts, or mixtures thereof.

8. The polymer composition as claimed in claim 7, said composition being, substantially free of β-diketone, β-diketone salts, or mixtures thereof.

9. The polymer composition as claimed in claim 7, further comprising a zinc salt.

10. The polymer composition as claimed in claim 7, further comprising a polyol.

11. A molding for use in the weathered outdoor sector, at least comprising a stabilizer composition as claimed in claim 1.

12. (canceled)

13. A process for the preparation of a polymer composition, comprising mixing with one another
(a) at least one stabilizing calcium compound or one mixture composed of two or more stabilizing calcium compounds as component A,
(b) at least one dye, at least one pigment or a mixture thereof as component B, where the at least one dye, the at least one pigment, or mixture thereof gives a halogen-containing thermoplastic resin the chromaticity coordinate L≦95, wherein a=0±>1 or b=0±>1 or a=0±>1 and b=0±>1,
(c) at least one isocyanurate bearing hydroxy groups as component C, and
(d) at least one halogen-containing thermoplastic resin or one mixture composed of two or more halogen-containing thermoplastic resins,
wherein the polymer composition after mixing comprises less than 0.1 phr of β-diketone, β-diketone salts, or mixtures thereof.

14. A molding for use in the weathered outdoor sector, at least comprising a polymer composition as claimed in claim 7.
